(19) United States
(12) Patent Application Publication
(10) Pub. No.: US 2015/0227689 A1
(43) Pub. Date: Aug. 13, 2015

(54) Efficient Framework for Healthcare Order Entry

(71) Applicant: Siemens Medical Solutions USA, Inc., Malvern, PA (US)

(72) Inventors: Sharon S. Taylor, Chester Springs, PA (US); Sumit Shrestha, Malvern, PA (US); Michael H. Lutz, Wayne, PA (US); Mark Alexander, Malvern, PA (US)

(73) Assignee: Siemens Medical Solutions USA, Inc., Malvern, PA (US)

(21) Appl. No.: 14/175,432

(22) Filed: Feb. 7, 2014

(51) Int. Cl. G06F 19/00

(52) U.S. Cl. CPC G06F 19/322; G06F 19/345

(57) ABSTRACT

Disclosed herein is a framework for facilitating efficient healthcare order entry. A system of the framework includes a user interface presented on a display device. In accordance with one aspect, the user interface is arranged to present one or more sets of favorite orders to a user. Further, the user interface is arranged to present at least one suggested order based on the system receiving a user selection of an order from the one or more sets of favorite orders.

### TECHNICAL FIELD

The present disclosure generally relates to systems and methods for entering healthcare orders.

### BACKGROUND

The most common way for a physician to delegate authority is to write an order on a patient's chart. The physician may personally write the order, or a nurse may enter it in the chart at the physician's direction. An order generally refers to an authoritative indication to be obeyed. Formal orders are valuable for clarifying the delegation of authority in a clinical setting, although they may be less commonly used in private offices.

There are several types of orders, such as laboratory orders, medication orders, therapeutic procedure orders, diagnostic test orders, etc. Different orders may have different characteristics. For example, with medication orders, the user needs to define the medication name, select the dosage, the route of administration, the frequency of administration (e.g., how many times a day), the schema of administration (e.g., every day, once a day, etc.), and any other medication specifics. If the medication is to be administered intravenously, the clinician may have to enter the rate of intravenous (IV) pump flow and other additional information. In other words, the instructions in the medication order can become very complex.

A computerized physician order entry (CPOE) system may be used to facilitate such order entry. In general, a CPOE system enables a physician to enter an order electronically instead of using paper charts. The physician may select, via the CPOE system, desirable items from a hospital's or health system's orderable services to generate the order.

The use of a CPOE system can help to reduce errors related to poor handwriting or transcription of orders. It can also reap financial rewards for physician practices or hospital systems by meeting government mandates. However, conventional CPOE systems are still not very user-friendly, and physicians who place orders through these systems often find it cumbersome to use. The reality is that the user of Electronic Medical Records (EMRs) or Electronic Health Records (EHRs) can take longer to complete documentation and place orders for medications, treatments and/or tests than in the “paper world.”

Some existing systems provide some features to enhance efficiency in order entry, such as narrowing the list of orderable services to include, for example, a personal favorite list. Such “favorite list,” however, is often a set of system-defined orders that are pushed out to the clinical end-users based on individual specialty. The clinical end-users do not have the ability to configure them, and they still need to complete the orders with many additional details prior to placing them.

Accordingly, there exists a need to provide an improved framework for facilitating efficient healthcare order entry.

### SUMMARY

The present disclosure relates to a framework for facilitating efficient healthcare order entry. A system of the framework includes a user interface presented on a display device. In accordance with one aspect, the user interface is arranged to present one or more sets of favorite orders to a user. Further, the user interface is arranged to present at least one suggestion for an alternate order based on the system receiving a user selection of an order from the one or more sets of favorite orders.

This summary is provided to introduce a selection of concepts in a simplified form that are further described below in the following detailed description. It is not intended to identify features or essential features of the claimed subject matter, nor is it intended that it be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings. Furthermore, it should be noted that the same numbers are used throughout the drawings to reference like elements and features.

FIG. 1 shows an exemplary computer system, in which the techniques and devices in accordance with the present disclosure may be embodied;

FIG. 2 is a flow diagram illustrating an exemplary process of efficient healthcare order entry;

FIG. 3 shows an exemplary service selection screen of a user interface, illustrating example contents of a personal favorites tab, according to an implementation;

FIG. 4 shows a Venn diagram illustrating an exemplary technique for determining suggested services based on multiple patient diagnoses;

FIG. 5 shows an exemplary order task screen of a user interface, illustrating example diagnosis-based suggested orders, according to an implementation;

FIG. 6 shows an exemplary screen of a user interface, illustrating exemplary order statistics based on patient diagnosis; and

FIG. 7 shows an exemplary service selection screen of a user interface.

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It is to be understood that the system and methods described herein may be implemented in various forms of hardware, software, firmware, special purpose processors, or a combination thereof. Preferably, the present invention is implemented in software as an application (e.g., n-tier application) comprising program instructions that are tangibly embodied on one or more program storage devices (e.g., magnetic floppy disk, RAM, CD ROM, ROM, etc.), and executable by any device or machine comprising suitable architecture. If written in a programming language conforming to a recognized standard, sequences of instructions designed to implement the methods can be compiled for execution on a variety of hardware platforms and for interface to a variety of operating systems. In addition, embodiments of the present framework are not described with reference to any particular programming language. It will be appreciated that a variety of programming languages may be used to implement embodiments of the present invention.

It is to be further understood that since at least a portion of the constituent system modules and method steps depicted in the accompanying Figures may be implemented in software, the actual connections between the system components (or the flow of the process steps) may differ depending upon the manner in which the present invention is programmed. Given the teachings herein, one of ordinary skill in the related art will be able to contemplate these and similar implementations or configurations of the present invention.

The present disclosure describes a framework (e.g., system) that facilitates efficient healthcare order entry. In accordance with one aspect of the framework, users are able to efficiently place, save, organize and/or share favorite orders. A “favorite order”, as used herein, generally refers to an order that is saved or stored in the computer system and selectable for future retrieval. The view of the user's favorite orders may be configured by the user. Analytics may be employed to assist the user in completing orders. Such features may also be incorporated in other sections of an electronic medical record (EMR) or electronic health record (EHR) system. For instance, the system may enable the user to configure the user's own view of the patient's clinical summary (e.g., patient chart). These exemplary advantages and features will be described in more detail in the following description.

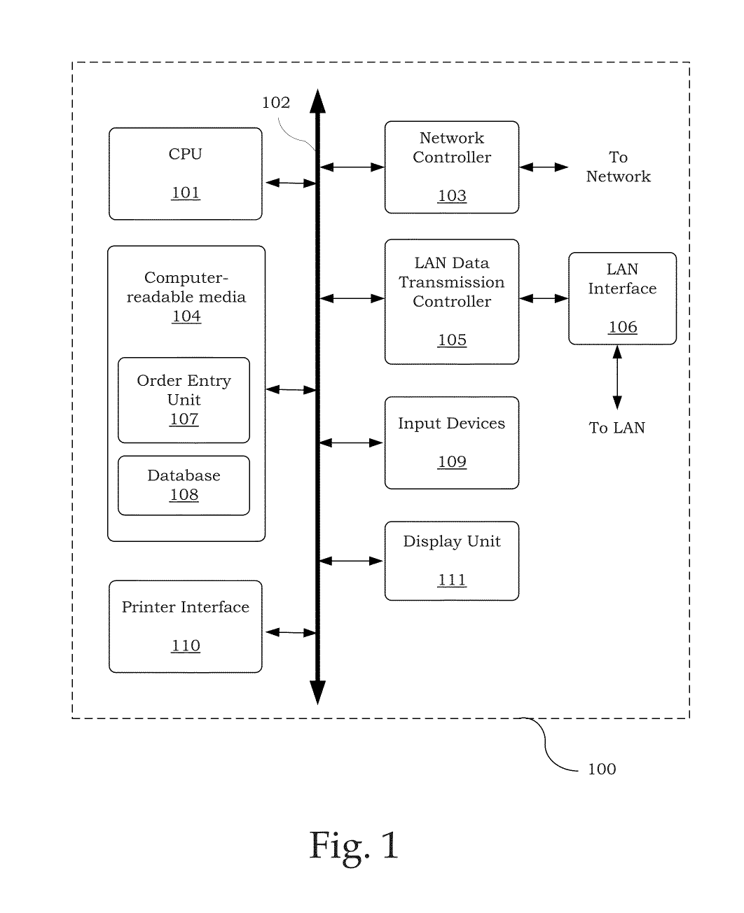

FIG. 1 shows an exemplary computer system for implementing a method and system of the present disclosure. The computer system referred to generally as system 100 may include, inter alia, a processor such as a central processing unit (CPU) 101, a non-transitory computer-readable media 104, a printer interface 110, a display unit 111, a local area network (LAN) data transmission controller 105, a LAN interface 106, a network controller 103, an internal bus 102, and one or more input devices 109, for example, a keyboard, mouse, touch screen, etc. Computer system 100 may further include support circuits such as a cache, a power supply, clock circuits and a communications bus. Various other peripheral devices, such as additional data storage devices and printing devices may also be connected to the computer system 100.

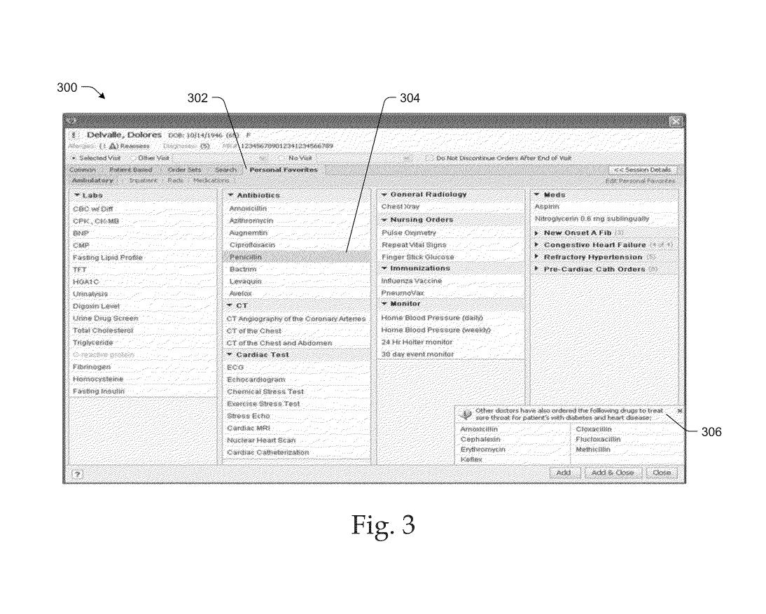

The present technology may be implemented in various forms of hardware, software, firmware, special purpose processors, or a combination thereof, either as part of the microinstruction code or as part of an application program or software product, or a combination thereof, which is executed via the operating system. In one implementation, the techniques described herein may be implemented as computer-readable program code tangibly embodied in non-transitory computer-readable media 104. Non-transitory computer-readable media 104 may include one or more memory storage devices such as random access memory (RAM), read only memory (ROM), magnetic floppy disk, flash memory, and other types of memories, or a combination thereof. The present techniques may be implemented by an order entry unit 107 that is stored in computer-readable media 104. Order entry unit 107 may generate a user interface (e.g., graphical user interface, see FIG. 3 for example) for ordering healthcare services or goods, such as laboratory tests, medications, radiology procedures, diagnostic tests, therapeutic procedures, and so forth. The user interface may be displayed (e.g., presented) on the display unit 111, for example. As such, the computer system 100 comprises a general purpose computer system that becomes a specific purpose computer system when executing the computer-readable program code.

The same or different computer-readable media 104 may be used for storing a database 108. The database 108 may include a repository of patient data of one or more patients. The patient data may include medical information associated with one or more patients, which may be used to complete orders for healthcare services or goods. The database 108 may further include one or more sets of favorite orders. Each set of favorite orders may be associated with a particular user or group of users. Other types of information, such as user configuration settings, security settings, may also be stored in the database 108.

It is to be understood that, because some of the constituent system components and method steps depicted in the accompanying figures can be implemented in software, the actual connections between the systems components (or the process steps) may differ depending upon the manner in which the present framework is programmed. For example, the system 100 may be implemented in a client-server, peer-to-peer (P2P) or master/slave configuration. In such configurations, the system 100 may be communicatively coupled to other systems or components via a network, such as an Intranet, a local area network (LAN), a wide area network (WAN), P2P, a global computer network (e.g., Internet), a wireless communications network, or any combination thereof. Given the teachings of the present invention provided herein, one of ordinary skill in the related art will be able to contemplate these and similar implementations or configurations of the present invention.

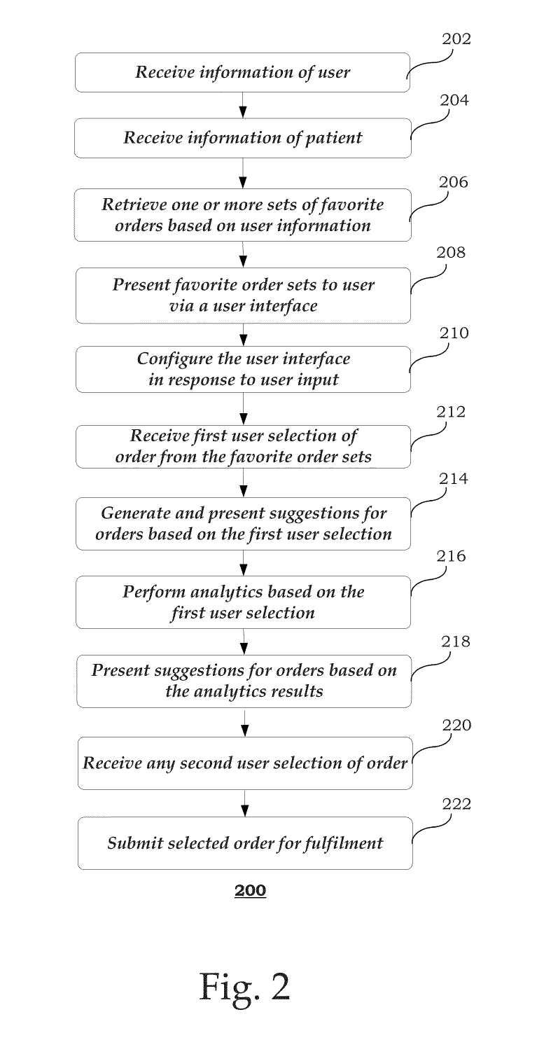

FIG. 2 shows an exemplary method 200 of healthcare order entry. The steps of the method 200 may be performed in the order shown or a different order. Additional, different, or fewer steps may be provided. Further, the method 200 may be implemented with the system 100 of FIG. 1, a different system, or a combination thereof. The method 200 is described with reference to FIGS. 1 and 3-7.

At 202, the order entry unit 107 receives information of a user. Such user information may include data items such as user identifier (e.g., name, physician number, social security number, contact information, department, specialty, etc.) and authorization level (e.g., administrator, physician, nurse, intern, etc.). In some implementations, the user logs onto the computer system 100, and more specifically, the order entry unit 107. The order entry unit 107 may use, for example, biometric features to identify and/or authenticate the user. The order entry unit 107 may authenticate the user by determining whether the user is a member of a predetermined group of authorized users. In an embodiment, the system 100 may determine which set(s) of favorite orders or which individual favorite orders are presented to the user via the user interface, based on receiving the user information.

In some implementations, each individual user may be associated with a set of privileges (i.e., permissions), based on predetermined security settings. Such privileges may allow the associated user to edit (e.g., add, delete), share, comment and/or configure favorite order sets. For instance, one exemplary security setting may provide a user with administrator authorization level privileges to push favorite orders to another user with intern authorization level privileges. Another exemplary security setting may disallow the intern user from editing the favorite orders pushed by the administrator user, or from adding other favorite orders. In one example, the intern user may only order from the favorite order sets that are pushed to him or her.

In various aspects, the system 100 includes security settings that define access to certain components of a favorite order user interface. For instance, one exemplary security setting may make the comments sections in specific users' favorite order sets available or allowable for use in search criteria or searches for orders by all users. Another exemplary security setting may limit a user's ability to edit certain tabs, sections, favorites and allow the user to edit others. For instance, the user may be presented with a user interface that includes a pre-compiled set of favorite orders and a quantity of selectable tabs. The security setting may enable the user to edit the pre-compiled favorite order set if the authorization level of the user allows him or her to do so. A user who does not have the appropriate authorization level privileges may, however, be allowed to create new tabs, including new favorite orders, and edit those.

At 204, the order entry unit 107 receives information of a patient. The patient information may include data items such as patient identifier (e.g., name, patient number, social security number, date of birth, address, contact information, etc.), patient-specific healthcare related information (e.g., allergies, admission date, referring physician, procedure identifier, medical history, etc.), information related to a patient-specific medical condition (e.g., a diagnosis for hypertension), and/or so forth. The patient information may be manually input by, for example, entering data into appropriate data fields via a user interface or via speech commands. Alternatively, the patient information may be automatically input by, for example, retrieving the patient information from a patient file in the database 108 in response to a user selecting a particular patient.

At 206, the order entry unit 107 retrieves one or more sets of favorite orders based on the user information and/or the patient information. The favorite orders may be retrieved from, for example, database 108, to populate fields in the current order with previously saved data. The one or more sets of favorite orders are previously saved by the current user or another user (e.g., another physician in the same practice group) associated with the current user.

Referring to FIG. 3, an exemplary view of a user interface 300 is illustrated, showing a favorite orders (“Personal Favorites”) tab 302 open for viewing. In the example shown in FIG. 3, the favorite orders view 302 may include one or more lists or sets of favorite orders in categories (e.g., Labs, Antibiotics, CT, Cardiac Test, General Radiology, Nursing Orders, Immunizations, Monitor, Meds, etc.) which may be presented on one or more screens of the user interface. The favorite orders may comprise a subset of the total quantity of orders stored in the system, and may be selected for efficient access by a user.

In various implementations, favorite orders may be shared between various users or groups of users. For instance, favorite orders may be shared between hospitals or between different physicians within a medical practice. A user may select one or more components (e.g., section, tab, etc.) or subset (e.g., single order) of a set of favorite orders for sharing. In addition, the user may designate particular users to share the favorite orders with. In some embodiments, sharing or receiving shared favorites is limited to users with associated permissions to do so.

Favorite orders may be shared or pushed from one user to another via electronic information transfer, such as the hospital electronic system (e.g., EMR, EHR, etc.), communications system (e.g., email, instant messaging, texting, etc.), information exchange system (e.g., MobileMD®), portable data storage devices (e.g., flash memory), and so forth. For example, a physician may select various components of his or her personal favorite order set and send them via the communications system to another associate for use.

In some implementations, a pre-built set of favorite orders may be copied in whole or in part. The pre-built set of favorite orders may be associated with one or more particular clinical users (e.g., physician). The favorite orders may also be deleted or dissociated with the user as desired (singly or multiple favorite orders at a time), based on having permissions or authorization. The set of favorite orders may be pre-built for a specific medical practice, specialty or to meet a particular patient care standard.

For example, an administrator user may “bootstrap” a new user by pushing a pre-built set of orthopedic-specific favorite orders to an entire body of orthopedic interns within a clinical rotation. Upon a change in the students' clinical rotation to cardiology, the administrator may delete the set of favorite orders and push another pre-built set of cardiology-specific favorite orders to the students. In another example, new favorite order sets or updates may be pre-built to meet new patient care criteria. The new favorite order sets may then be pushed to users based on the users' specialty.

At 208, the order entry unit 107 presents the favorite order sets to the user, via the user interface 300 (or the like) as shown in FIG. 3. In various aspects, the system 100 is arranged to include sorting of favorite orders within sections of favorite orders and within tabs. For instance, the favorite orders may be sorted alphabetically in an ascending or descending order, by category, and the like. In an example, the sorted view may be saved by the user as a default view or selectable view.

In some implementations, the system 100 is arranged to allow a user to add a note or an alert to an order. For instance, the system 100 may provide a note icon at the end of the order name, for example, when a note is attached. In some cases, different colors of note icons or different designs of note icons may be used to distinguish between self-reminders, diagnosis notes, and portability notes, for ease of recognition.

Various types of notes may be supported in various aspects. For example, a self-reminder or comment (e.g., note to self) may be added by a user as a reminder about the order (e.g., “Pediatric dose, infection, 80% success rate in children over 5,” including a citation to an article or a hyperlink which can be used during order entry).

Another type of note may include a portability note. For example, a user may leave notes for other users when messaging a set of favorite orders to the other users. The portability note could help the other users identify where in their personal favorites they want to store the order or how they want to use it, for example.

Further, another type of note may include one that is added to a diagnosis, so that the notes can be queried by other users of the set(s) of favorite orders within the hospital system or physician practice. For example, a user may add a note to a Diovan medication order with the word “hypertension.” Upon using search criteria of “hypertension,” the Diovan medication service is returned. In one example, the search return may include a number of times Diovan has been ordered within the hospital system or physician practice (described further below).

In an implementation, the user interface 300 includes a search component within the edit feature of favorite orders that is arranged to search the alias (i.e., a name the user gives the order), order name, section name, tab name, and comment field). In the implementation, the search can return a list of service orders along with the quantity of services returned. These orders may also be highlighted until the search is cleared. For example, this feature may allow a user to avoid adding duplicate or rarely used favorite orders, thereby increasing efficiency during order entry.

At 210, the order entry unit 107 configures the user interface 300 in response to user input. For example, if the user has the associated permissions to make changes to the layout of the user interface 300, the order entry unit 107 may configure (or re-configure) a view of one or more sets of the favorite orders, for example, in response to user input, as desired. In some implementations, one or more views of the user interface 300 are configurable by the user, and some views may not be configurable, based on the permissions associated to the user. For example, the user may configure a desired view of a set of favorite orders or of a patient summary (e.g., patient chart) according to his/her preference (including layout, colors, categories, sections, sequence, and the like). In an example, the user may also undo changes made to the view(s) via interface controls, returning the view of favorite orders or patient charts to the original layout.

At 212, the order entry unit 107 receives a first user selection of an order from the one or more sets of favorite orders. In various implementations, the user may make the selection via one or more input devices (e.g., touchscreen, keyboard, mouse, stylus, voice input, etc.). In some aspects, a selection from one of the favorite orders includes details of the order, such as dosage, route, frequency, schema, duration, and the like (providing “one-click ordering,” for example).

At 214, the system 100 generates and presents (via the order entry unit 107) suggestions for alternate orders (i.e., substitute or additional orders) based on the first user selection. This is shown in FIG. 3, on an exemplary service selection screen of user interface 300, illustrating the selection of “penicillin” (at 304) in the “Antibiotics” category by a user. When the order is selected from the set(s) of favorite orders, a message box 306 (or the like) may appear in a portion of the screen, displaying at least one suggestion for an alternate order. The user may select another order from the suggested orders, to replace and/or to add to the user's first selection of an order. In some implementations, the message box 306 may include information as well as a list of suggested orders. For example, the information may include data associated with other user selections of the suggested order.

At 216, the order entry unit 107 performs analytics based on the first user selection. For example, in an embodiment, the system 100 can collect statistics that rank the most frequently ordered services based on patient diagnoses. These statistics enable the system 100 to sort the intersected set of services most frequently ordered for any combination of diagnoses.

In one example, a periodic (e.g., daily, weekly, etc.) job can query all the orders placed in that period and the diagnoses assigned for the patients' visits that are associated to each order. A cumulative count of the number of times a given service is placed per diagnosis can be maintained. Multiple tables may be used to properly construct this information. One table can store a list of services ordered over a 60 day period, for example, and for meds, the drug classification may also be included in this table. Another table can include a list of diagnoses assigned to patients over the last 60 days (in the example). As this periodic job executes, it can append to these lists as needed. A third table can include a mapping between these other two tables. This mapping table can contain the aggregate ordering frequency over the 60 day period (for example) for each combination of service and diagnosis. With this information, the system 100 can determine what services are most frequently ordered for each diagnosis code. And with the additional information of drug classification in the first table, the system 100 can further provide decision support capabilities for users such as physicians, by filtering suggestions based on the drug classifications derived during data entry.

In an implementation, the system 100 can also provide the ability for a user to associate his/her personal favorite orders with diagnosis codes of his/her choosing in addition to those derived based on historical data analysis. This can further strengthen the system's decision support capabilities. When saving a personal favorite order, the user will have an option to associate one or more diagnoses to the favorite order. In aggregated statistics, such associations can carry additional statistical significance.

From this information, the system 100 can use the intersection of the sets of services ordered based on the patient's diagnoses. Within this set, the system 100 can rank the services' likelihood of clinical effectiveness, for example. Additionally, a set can be filtered and expanded by drug classification, if desired.

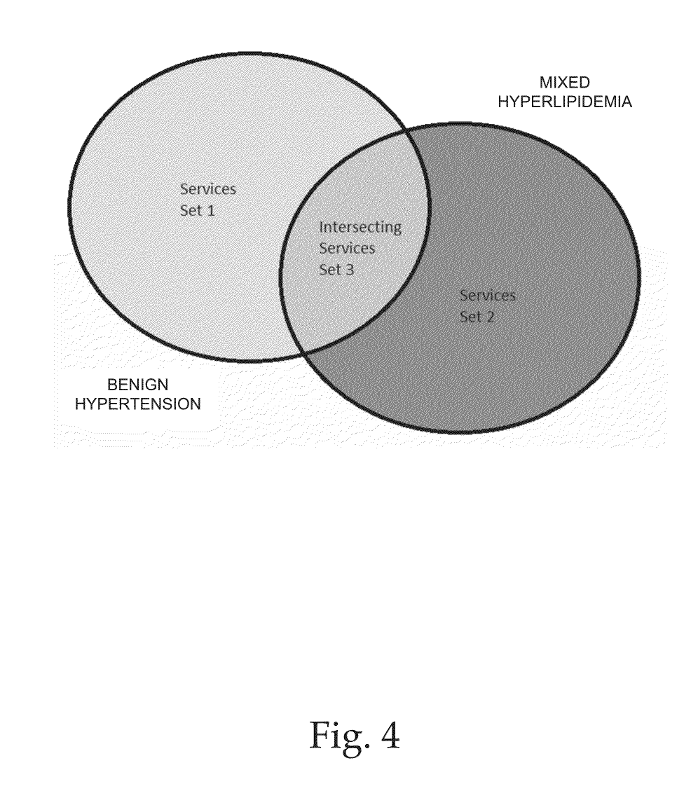

FIG. 4 shows a Venn diagram illustrating an example technique for determining suggested services based on multiple patient diagnoses. Saving multiple diagnoses to an “order favorites” table when an order is saved to favorites can allow statistics to be returned for a combination of diagnosis. For example: placing an order for Diovan (for blood pressure issues) on a patient that has hyperlipidemia as well as hypertension can return a message on a portion of the user interface 300 that indicates, for instance, “People who chose this medication for a patient with these two diagnosis also ordered . . . ,” thus offering “smart” order suggestions (i.e., therapeutic derived services).

The Venn diagram of FIG. 4 illustrates how therapeutic derived services can be determined. For diagnosis 1—benign hypertension—the system 100 stores the set of services most frequently ordered in memory 104, services set 1. Similarly, for diagnosis 2—mixed hyperlipidemia—the system 100 stores a different set in memory 104, services set 2. The intersection of these services sets can be further filtered real-time by the drug classification during data entry by a care provider, for example, providing even stronger therapeutic based decision support.

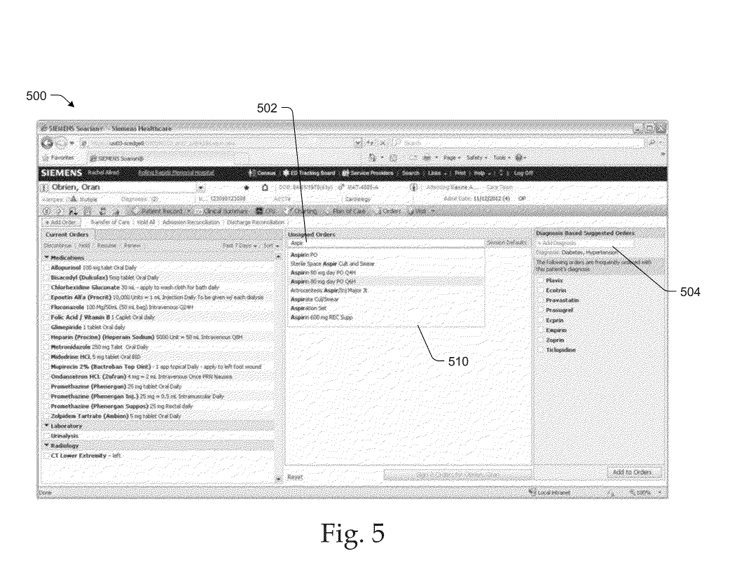

At 218, the order entry unit 107 presents at least one suggestion for an order based on analytics results. FIG. 5 shows an example order task screen 500 of a user interface, illustrating example diagnosis-based suggested orders, according to an implementation. In the implementation, the system 100 provides a “type-ahead” search functionality for finding orders to add to, or to replace, the user's first selection of order. For example, a user can type a search term in a type-ahead search area 502, and receive a list 510 of suggested orders based on the current typed characters, dynamically changing as more characters are entered in the area 502.

Alternatively, the system 100 may display the suggested orders based on the user's diagnosis (added at 504, for example) when the user searches for orders. In one example, the system 100 can refine the suggestions, based on the user's search.

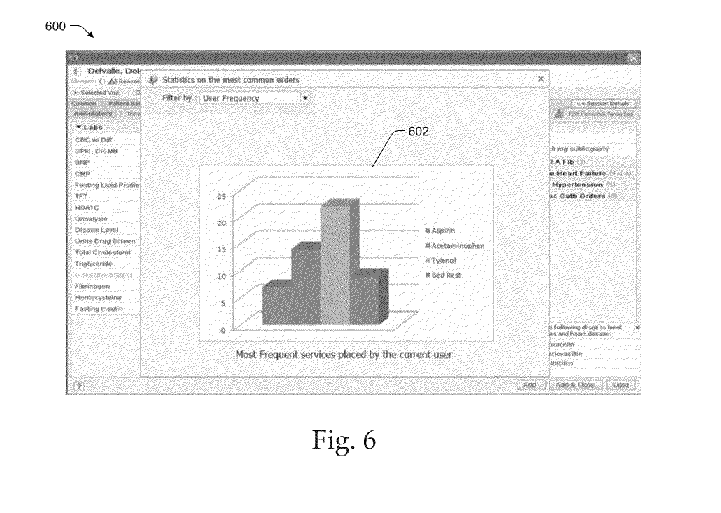

FIG. 6 shows an example screen 600 of a user interface, illustrating exemplary order statistics based on patient diagnosis. Statistical feedback, such as that shown in FIG. 6, may be provided to users based on various activities. In an example, users can view statistics at different levels, and in various forms (such as the bar chart 602 shown in FIG. 6). The statistics could include the specific user frequency of an order, shown by specialty frequency (Example: Cardiology), by nursing station or single doctor's office, by an entire hospital or physician practice, or the like. For example, a user can view statistics data associated with the most common orders. Using a filter menu, for example, the user can filter the data sets to view specific statistics, such as most frequent orders placed by currently logged in user, most frequent orders by specialty, most frequent orders by departments, entities, enterprise, etc.

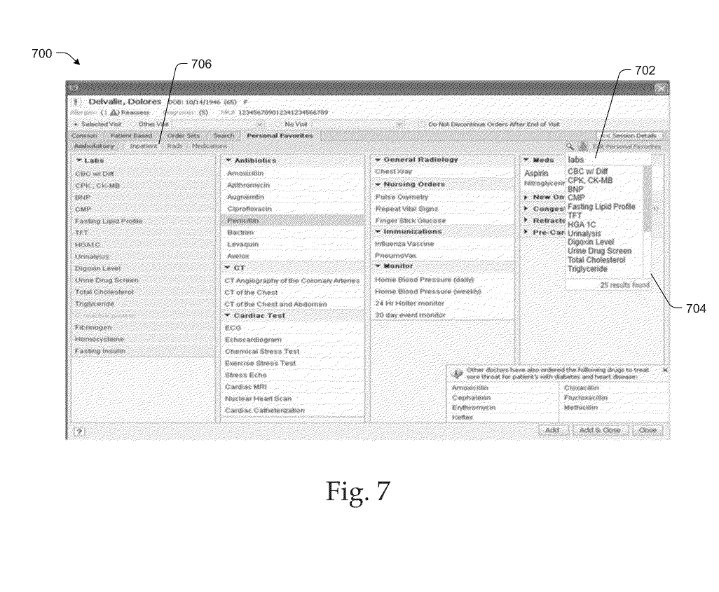

FIG. 7 shows an example service selection screen 700 of a user interface, illustrating another exemplary search function. In the example shown, notifications may appear to guide a user to search results.

In some implementations, a search field 702 (or the like) may be used during ordering or editing from the user favorite orders, to search the alias, order name, section name, tab name, comment field, and so forth. The search may return a list 704 of orders along with the number of orders returned. These orders will also be highlighted until the search is cleared. The system 100 will also highlight the matching services, aliases, comments, and diagnosis in the personal favorite display. In an embodiment, if the search results are in tabs that are not currently active, the tab headers will be highlighted (shown at 706). In various embodiments, the same functionality is available in the personal favorites edit screen as well. This will allow the user to see what orders other users are selecting for an associated diagnosis. Also, the search function can help the user to quickly find where orders reside within his/her favorites.

Returning back to FIG. 2, at 220, the order entry unit 107 receives any second user selection of an order. The second user selection may be made from the suggested orders or from one of the user's favorite order set(s). For example, in an implementation, the system 100 may receive a user selection of a second order based on at least one suggested order or a user selection of another order from the favorite order set(s), or the system 100 may receive a confirmation of the first user selection from the user. Accordingly, the user may choose to maintain his/her first selected order, add to and/or substitute it for one of the alternate orders suggested by the system 100.

At 222, the order entry unit 107 submits the selected first order, the second order or both orders (including multiple orders) for fulfilment, based on the user input.

While the present invention has been described in detail with reference to exemplary embodiments, those skilled in the art will appreciate that various modifications and substitutions can be made thereto without departing from the spirit and scope of the invention as set forth in the appended claims. For example, elements and/or features of different exemplary embodiments may be combined with each other and/or substituted for each other within the scope of this disclosure and appended claims.

1. Non-transitory computer-readable storage media having computer-executable instructions stored thereon, that when executed, cause a processor to execute steps comprising:
retrieving one or more sets of favorite orders;
presenting the one or more sets of favorite orders to a user via a user interface;
receiving a first user selection of a first order from the one or more sets of favorite orders;
performing analytics based on the first user selection;
generating and presenting at least one suggested order based on a result of the analytics;
receiving a second user selection of a second order based on the at least one suggested order; and
submitting the selected first order, second order or both orders for fulfilment.

2. The computer-readable storage media of claim 1, the computer-executable instructions further causing the processor to
determine at least one of: which favorite orders are presented to the user, whether the user has authorization to edit the favorite orders, whether the user has permission to create and/or edit notes associated to the favorite orders, whether the user has authorization to submit an order other than one of the favorite orders, and whether the user may share favorite orders with another user, based on receiving user information.

3. A method, comprising:
presenting one or more sets of favorite orders to a user via a user interface;
receiving a first user selection of a first order from the one or more sets of favorite orders;
generating and presenting at least one suggested order based on the first user selection;
receiving a second user selection of a second order based on the at least one suggested order; and
submitting the selected first order, second order or both orders for fulfilment.

4. The method of claim 3, further comprising:
receiving user information or patient information; and
retrieving the one or more sets of favorite orders based on the user information or the patient information.

5. The method of claim 3, further comprising configuring, based on permissions associated with received user information, a view of one or more sets of the favorite orders in response to user input.

6. The method of claim 3, further comprising:
performing analytics based on the first user selection; and
generating and presenting the at least one suggested order based on the results of the analytics.

7. The method of claim 3, further comprising pushing one or more sets of the favorite orders or updates to the one or more sets of favorite orders to another user or to a group of users.

8. The method of claim 3, further comprising:
editing one or more sets of the favorite orders; and
forming one or more new sets of favorite orders based on user input.

9. The method of claim 8, further comprising limiting the editing and the forming based on permissions associated with the user.

10. The method of claim 3, further comprising sharing one or more sets of the favorite orders with another user or with a group of users via electronic information transfer.

11. The method of claim 3, further comprising periodically presenting one or more different sets of favorite orders based on scheduled user rotations.

12. A system, comprising:
a processor;
one or more memory storage devices coupled to the processor;
an order entry unit including processor-executable instructions stored in the one or more memory storage devices and operable on the processor to:
generate a user interface for ordering healthcare services and/or goods;
present one or more sets of favorite orders to a user via the user interface; and
present at least one suggested order based on a user selection of an order from the one or more sets of favorite orders; and
a display unit arranged to display the user interface to the user.

13. The system of claim 12, further comprising a database component stored in the one or more memory storage devices and including the one or more sets of favorite orders.

14. The system of claim 12, wherein the system is arranged to allow the user to place, save, organize, select, share the favorite orders, or a combination thereof.

15. The system of claim 12, wherein the system is arranged to suggest an order based on a patient diagnosis or based on a combination of multiple diagnoses of a patient.

16. The system of claim 12, wherein the system is arranged to analyze data regarding orders selected for corresponding diagnoses by multiple users, and to generate the at least one suggested order based on the analysis.

17. The system of claim 12, wherein the user interface includes a message portion arranged to present the at least one suggested order and information associated with other user selections of the at least one suggested order.

18. The system of claim 12, wherein the system is arranged to present notes, annotations, other user comments, and/or cross-references to other orders based on the user selection of an order from the one or more sets of favorite orders.

19. The system of claim 12, wherein the order entry unit is arranged to allow a user to edit a view of the one or more sets of favorite orders, including adding new favorite orders, based on permissions associated to the user.

20. The system of claim 12, wherein the healthcare services and/or goods comprise one or more of laboratory tests, medications, radiology procedures, diagnostic tests, and therapeutic procedures.
